(19) United States
(12) Patent Application Publication
(10) Pub. No.: US 2016/0035365 A1
(43) Pub. Date: Feb. 4, 2016

(54) SOUND ENCODING DEVICE, SOUND ENCODING METHOD, SOUND DECODING DEVICE AND SOUND DECODING METHOD

(71) Applicant: FUJITSU LIMITED, Kawasaki-shi (JP)

(72) Inventors: Akira KAMANO, Kawasaki (JP); Yohei KISHI, Kawasaki (JP); Takeshi OTANI, Kawasaki (JP)

(73) Assignee: Fujitsu Limited, Kawasaki (JP)

(21) Appl. No.: 14/751,714

(22) Filed: Jun. 26, 2015

(30) Foreign Application Priority Data
Aug. 1, 2014 (JP) 2014-157897

(51) Int. Cl. G10L 19/125; G10L 19/028

(52) U.S. Cl. CPC G10L 19/125; G10L 19/028

(57) ABSTRACT

A sound encoding device includes: a processor; and a memory which stores a plurality of instructions, which when executed by the processor, cause the processor to execute: converting a sound signal into a frequency signal by time-frequency converting the sound signal in a unit of a frame having a given time length; detecting a first frequency band in which a phase component of the frequency signal is random for each frame; determining outline information representative of an outline of an amplitude component of the frequency signal included in the first frequency band for each frame; encoding the frequency signal included in a frequency band other than the first frequency band for each frame; and producing a data stream including the encoded frequency signal and the outline information.

### CROSS-REFERENCE TO RELATED APPLICATION

This application is based upon and claims the benefit of priority from the prior Japanese Patent Application No. 2014-157897 filed on Aug. 1, 2014, the entire contents of which are incorporated herein by reference.

### FIELD

The embodiment disclosed herein relates, for example, to a sound encoding device, a sound encoding method, a sound decoding device, and a sound decoding method.

### BACKGROUND

Background noise of a sound signal sometimes has a characteristic proximate to the characteristic of colored noise such as white noise or pink noise. As a technology that may encode environmental sound at a low rate using such a characteristic as just mentioned, such sound encoding technologies as code excited linear prediction (CELP) and noise excited linear prediction (NELP) are disclosed, for example, in Japanese National Publication of International Patent Application No. 2008-533530.

For example, according to CELP, a sound encoding device extracts a linear prediction filter coefficient of a sound source from a sound signal of an encoding target and transmits the linear prediction filter coefficient to a sound decoding device. Meanwhile, the sound decoding device convolves, within a sound interval, the linear prediction filter coefficient into a signal having a high tone property. On the other hand, within a silent interval, the sound decoding device convolves the linear prediction filter coefficient into white noise to decode the sound signal.

### SUMMARY

According to an aspect of the embodiment, a sound encoding device includes: a processor; and a memory which stores a plurality of instructions, which when executed by the processor, cause the processor to execute: converting a sound signal into a frequency signal by time-frequency converting the sound signal in a unit of a frame having a given time length; detecting a first frequency band in which a phase component of the frequency signal is random for each frame; determining outline information representative of an outline of an amplitude component of the frequency signal included in the first frequency band for each frame; encoding the frequency signal included in a frequency band other than the first frequency band for each frame; and producing a data stream including the encoded frequency signal and the outline information.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

These and/or other aspects and advantages will become apparent and more readily appreciated from the following description of the embodiments, taken in conjunction with the accompanying drawing of which:

FIG. 1 is a view depicting an example of an amplitude spectrum of environmental sound that includes a tone component and a noise component;

FIG. 2A is a view depicting an amplitude spectrum of a sound signal reproduced from an encoded sound signal, which is obtained by encoding environmental sound depicted in FIG. 1 in accordance with CELP, by convolving a linear prediction filter coefficient into a noise component;

FIG. 2B is a view depicting an amplitude spectrum of a sound signal reproduced from an encoded sound signal, which is obtained by encoding environmental sound depicted in FIG. 1 in accordance with CELP, by convolving a linear prediction filter coefficient into a tone component;

FIG. 3 is a view illustrating an overview of a sound encoding process and a sound decoding process;

FIG. 4 is a schematic block diagram of a sound encoding device according to an embodiment;

FIG. 5 is a view depicting an example of a data format in which an encoded audio signal is placed;

FIG. 6 is an operation flow chart of a sound encoding process;

FIG. 7 is a view illustrating an outline of a sound decoding process;

FIG. 8 is a schematic block diagram of a sound decoding device;

FIG. 9 is an operation flow chart of a sound decoding process;

FIG. 10 is a view depicting an example of a table indicative of a range of a value of an appearance frequency for each run length;

FIG. 11 is an operation flow chart of a phase random band detection process according to a modification; and

FIG. 12 is a block diagram of a computer that operates as a sound encoding device or a sound decoding device according to any one of the embodiment and modifications.

### DESCRIPTION OF EMBODIMENT

In the following, a sound encoding device is described with reference to the drawings. In such an application as an application in which whether or not some abnormality exists is checked from a sound signal collected by a microphone provided in a monitoring camera, preferably also environmental sound may be reproduced with high quality. Therefore, the present sound encoding device encodes a sound signal at a low rate while improving the reproduction sound quality of a sound signal that includes both of a tone component and a noise component. First, environmental sound including a tone component and a noise component is described.

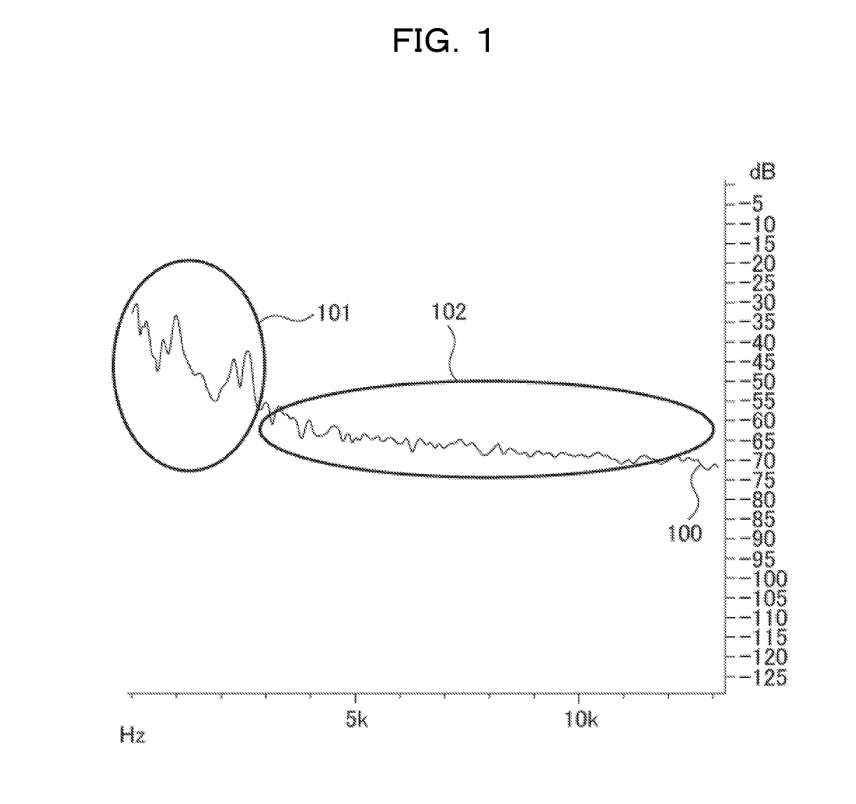

FIG. 1 is a view depicting an example of an amplitude spectrum of environmental sound that includes a tone component and a noise component. Referring to FIG. 1, the axis of abscissa represents the frequency and the axis of ordinate represents the intensity of the amplitude spectrum. An amplitude spectrum 100 here is an amplitude spectrum of environmental sound including a tone component and a noise component. In the example depicted in FIG. 1, components of relatively low frequencies indicated by a round mark 101 are tone components having a periodic pattern while components of relatively high frequencies indicated by a round mark 102 are noise components having a random pattern. Such environmental sound as just described is generated in such an environment that, for example, as at the station platform, sound from a specific sound source such as a bell and other noise exist in a mixed manner.

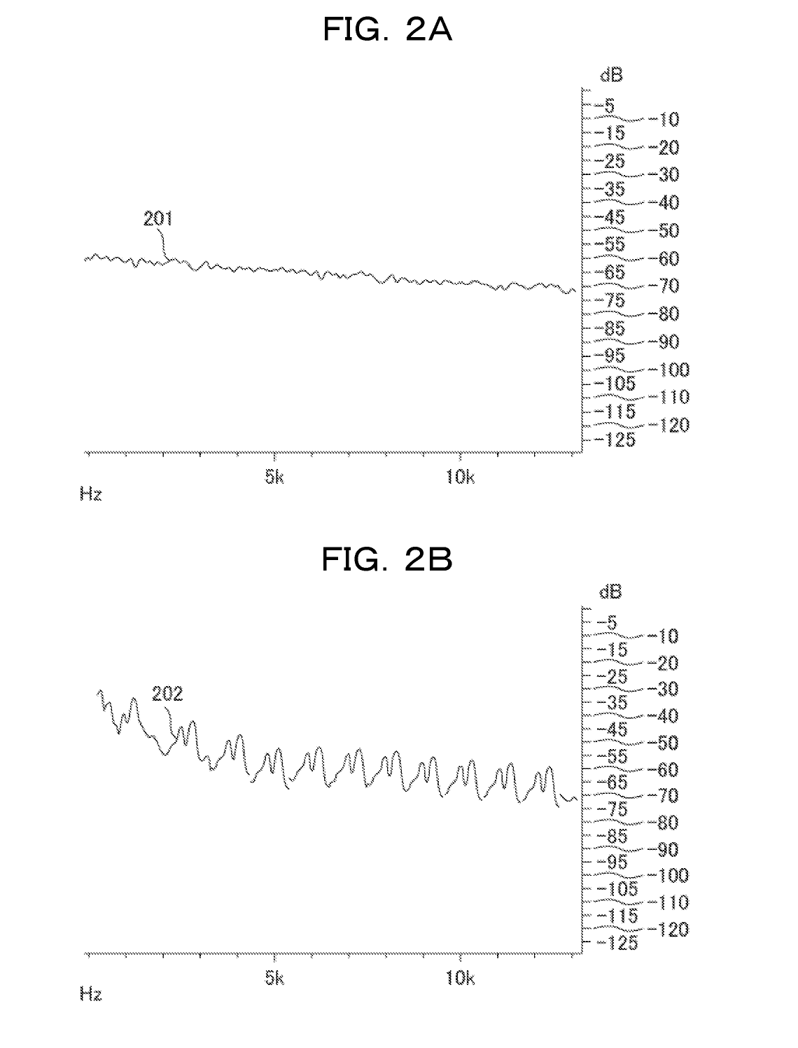

FIG. 2A is a view depicting an amplitude spectrum of a sound signal reproduced from an encoded sound signal, which is obtained by encoding environmental sound depicted in FIG. 1 in accordance with CELP, by convolving a linear prediction filter coefficient into a noise component. FIG. 2B is a view depicting an amplitude spectrum of a sound signal reproduced from an encoded sound signal, which is obtained by encoding environmental sound depicted in FIG. 1 in accordance with CELP, by convolving a linear prediction filter coefficient into a tone component. In FIGS. 2A and 2B, the axis of abscissa represents the frequency and the axis of ordinate represents the intensity of the amplitude spectrum. As depicted in FIG. 2A, in an amplitude spectrum 201 of the sound signal reproduced by convolving a linear prediction filter coefficient into noise components, some tone components are lost in comparison with the amplitude spectrum 100 depicted in FIG. 1. Meanwhile, as depicted in FIG. 2B, in an amplitude spectrum 202 of the sound signal reproduced by convolving the linear prediction filter coefficient into tone components, some noise components are lost in comparison with the amplitude spectrum 100 depicted in FIG. 1. Therefore, these reproduction sound signals are degraded in sound quality from the original sound signal.

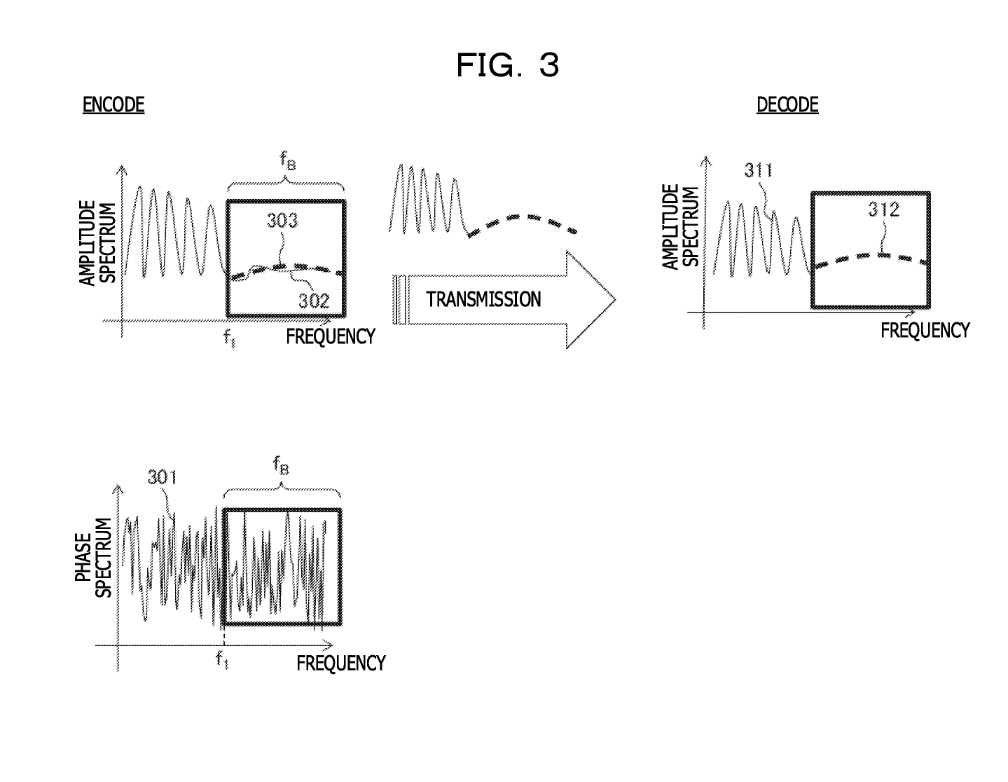

Therefore, the sound encoding device according to the present embodiment detects, from a frequency signal obtained by time-frequency converting a sound signal of an encoding target in a unit of a frame, a frequency band whose phase spectrum that is a phase component of the frequency signal is random as a frequency band including a noise component. FIG. 3 is a view illustrating an overview of a sound encoding process and a sound decoding process. For example, it is assumed that, in a phase spectrum 301 depicted in FIG. 3, the phase spectrum is random in a frequency band f_{B} higher than a frequency f₁. In this case, it is estimated that the frequency signal included in the frequency band f_{B} is a noise component. Therefore, the sound encoding device determines an outline shape 303 of an amplitude spectrum 302, which is an amplitude component of the frequency signal, in the frequency band f_{B}. Meanwhile, since it is estimated that the frequency band other than the frequency band f_{B} includes a tone component, the sound encoding device performs an encoding process for the frequency band other than the frequency band f_{B} to determine an encoded sound signal. Then, the sound encoding device includes a parameter representative of the outline shape 303 as outline information in an encoded sound signal. On the other hand, a sound decoding device determines a frequency signal 311 of the frequency band other than the frequency band f_{B} by decoding an encoded sound signal. Further, for the frequency band f_{B}, the sound decoding device artificially reproduces, on the basis of a parameter indicative of an outline shape and included in the encoded sound signal, a frequency signal 312 whose phase spectrum is random and whose amplitude spectrum forms the outline shape represented by the parameter. Then, the sound decoding device frequency-time converts the frequency signal in the overall frequency band obtained by synthesizing the obtained frequency signals of the frequency bands to reproduce a sound signal including the tone component and the noise component.

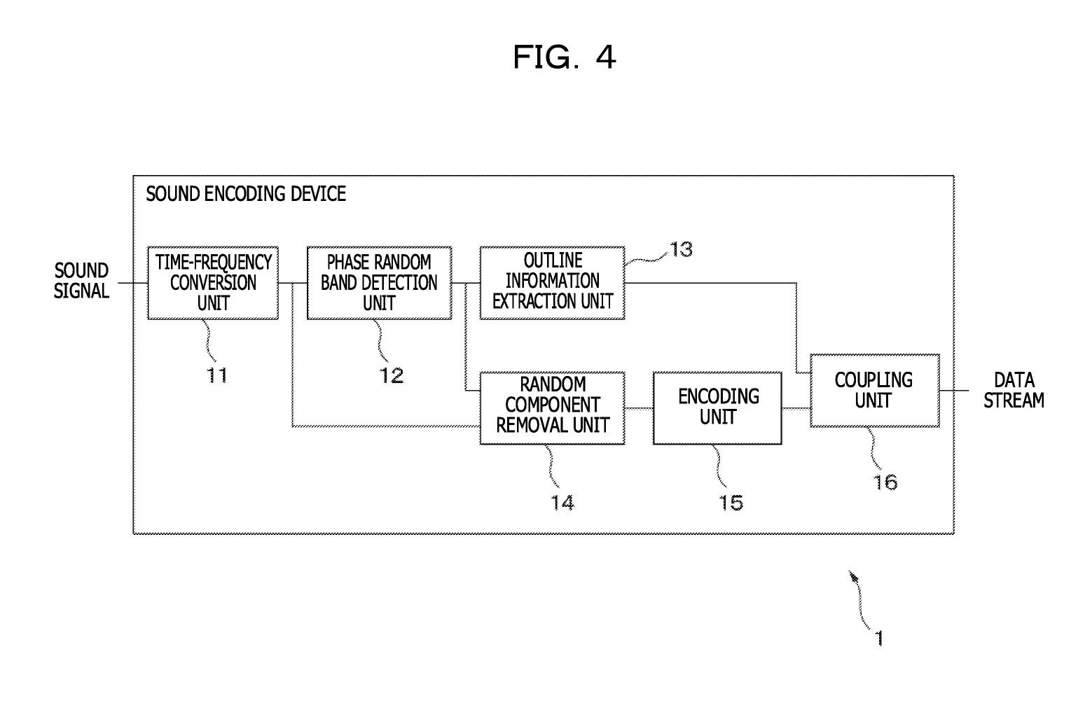

FIG. 4 is a schematic block diagram of a sound encoding device according to an embodiment. A sound encoding device 1 includes a time-frequency conversion unit 11, a phase random band detection unit 12, an outline information extraction unit 13, a random component removal unit 14, an encoding unit 15, and a coupling unit 16. The components of the sound encoding device 1 are formed, for example, as individually different circuits. Alternatively, the components of the sound encoding device 1 may be incorporated as a single integrated circuit, in which circuits individually corresponding to the components are integrated, in the sound encoding device 1. Alternatively, the components of the sound encoding device 1 may be a functional module implemented by a computer program that is executed on a processor the sound encoding device 1 includes.

For example, a sound signal collected by a microphone (not depicted) and digitalized by an analog/digital converter (hereinafter referred to as A/D converter) (not depicted) is inputted to the sound encoding device 1.

The time-frequency conversion unit 11 divides the digitalized sound signal (hereinafter referred to simply as sound signal) into units of a frame having a given length (for example, several tens milliseconds). Then, the time-frequency conversion unit 11 time-frequency converts the sound signal for each frame to calculate a frequency signal that is a signal in a frequency domain. It is to be noted that the number of frequency signals included in one frame is determined, for example, on the basis of the number of sampling points by the A/D converter included in one frame. Further, the time-frequency conversion unit 11 may use, for example, fast Fourier transform (FFT) or modified discrete cosine transform (MDCT) for the time-frequency conversion.

Every time calculating a frequency signal in a unit of a frame, the time-frequency conversion unit 11 outputs the frequency signal to the phase random band detection unit 12 and the random component removal unit 14.

The phase random band detection unit 12 detects a frequency band estimated to include a noise component and having a random phase spectrum on the basis of a phase spectrum that is a phase component of a frequency signal for each frame.

In the present embodiment, the phase random band detection unit 12 divides an overall frequency band that includes a phase spectrum into a plurality of sub bands. It is to be noted that one sub band has a frequency bandwidth of, for example, 100 Hz to 1 kHz. Then, the phase random band detection unit 12 determines for each sub band whether or not the phase spectrum is random.

If the difference in appearance frequency between different values of the phase spectrum in a focused sub band is small, then the phase random band detection unit 12 determines that the phase spectrum included in the sub band is random. The phase random band detection unit 12 divides, for example, a range [−π, π] that may be assumed by the value of the phase spectrum equally into M portions (where M is an integer equal to or greater than 2 and is, for example, 2 to 10) to set M partial intervals for the value of the phase. For example, where M=3, the partial intervals are given as [−π, −π/3], [−π/3, π/3] and [π/3, π]. The phase random band detection unit 12 specifies, for each frequency included in the focused sub band, a partial interval in which the value of the phase spectrum of the frequency is included. Then, every time a phase spectrum value included in each of the partial intervals k (k=0, 1, . . . , m-1) is found, the phase random band detection unit 12 adds 1 to the appearance frequency p1(k) in the partial interval to determine the appearance frequency p1(k) (k=0, 1, . . . , m-1) for each partial interval.

If the appearance frequencies p1(k) in the partial intervals in the focused sub band indicate a uniform distribution, then the phase random band detection unit 12 determines that the phase spectrum included in the sub band is random. For example, if all of the appearance frequencies p1(k) of the partial intervals are lower than a given threshold value, then the phase random band detection unit 12 determines that the appearance frequencies p1(k) in the partial intervals have a uniform distribution. On the other hand, the appearance frequency p1(k) in any one of the partial intervals is equal to or higher than the given threshold value, then the phase random band detection unit 12 determines that the appearance frequencies p1(k) in the partial intervals do not have a uniform distribution. It is to be noted that the given threshold value may be set to a value, for example, obtained by multiplying a value obtained by dividing the total number of frequencies in which a frequency signal included in a sub band is calculated by M by 1.1 to 1.3.

Alternatively, the phase random band detection unit 12 may apply a x-square test or a Kolmogorov-Smirnov test to the appearance frequencies p1(k) in the partial intervals to determine the adaptability between the appearance frequencies p1(k) in the partial intervals and a uniform distribution. Then, the phase random band detection unit 12 may determine, if the adaptability is equal to or higher than a given threshold value, that the appearance frequencies p1(k) in the partial intervals have a uniform distribution, but may determine, if the adaptability is lower than the given threshold value, that the appearance frequencies p1(k) in the partial intervals do not have a uniform distribution.

Alternatively, the phase random band detection unit 12 may generate a partial interval sequence in which numbers of partial intervals in which a value of a phase spectrum of each of the frequencies included in the focused sub band is included are lined up. Then, the phase random band detection unit 12 may check the appearance frequency of each of a plurality of permutation patterns that are patterns of lined up numbers of the partial intervals included in the partial interval sequence. Then, if the appearance frequencies of the permutation patterns exhibit a uniform distribution, then the phase random band detection unit 12 determines that the phase spectrum included in the focused sub band is random.

In this case, the phase random band detection unit 12 allocates numbers from 0 to M-1 successively to the M partial intervals obtained by equally dividing the range [−π, π], which may be assumed by the value of the phase, into M. Then, the phase random band detection unit 12 lines up the numbers of the partial intervals in which phases of frequencies included in the focused sub band are included, for example, in an ascending order of the frequency to generate a partial interval sequence. For example, where the values of phase spectrum of the frequencies are included in an ascending order of the frequency in the first, 0th, second, first, second and 0th partial intervals, the partial interval sequence is [1, 0, 2, 1, 2, 0].

Further, a plurality of permutation patterns individually have a plurality of elements smaller than the elements of the partial interval sequence, and each element represents a number of the partial interval. For example, the permutation pattern having three elements is defined like [0, 1, 2] or [1, 1, 0]. It is to be noted that the permutation patterns are determined in advance and are stored in advance, for example, in a memory the phase random band detection unit 12 includes.

The phase random band detection unit 12 determines whether or not the partial interval sequences in the focused sub band coincide with the permutation patterns in order beginning with the top partial interval sequence. Then, if the phase random band detection unit 12 founds out a portion which coincides with some permutation pattern, then the phase random band detection unit 12 adds 1 to the appearance frequency p2(j) for the permutation pattern j (j=0, 1, . . . , J-1, where J is the total number of permutation patterns). The phase random band detection unit 12 thereby determines an appearance frequency p2(j) (j=0, 1, . . . , J-1) for each permutation pattern.

Also in this example, when the appearance frequencies p2(j) for the permutation patterns in the focused sub band have a uniform distribution, the phase random band detection unit 12 determines that the phase spectrum included in the sub band is random. Further, similarly as in the embodiment described above, when the appearance frequencies p2(j) for the permutation patterns are lower than the given threshold value, or when the adaptability obtained by a x-square test or the like is equal to or higher than the given threshold value, the phase random band detection unit 12 determines that the appearance frequencies p2(j) have a uniform distribution.

Alternatively, the phase random band detection unit 12 produces a phase spectrum sequence φ(j) (j=0, 1, . . . , N-1, where N is the total number of frequencies included in the sub band) in which values of a phase spectrum of frequencies included in the focused sub band are lined up in a given order. It is to be noted that the given order may be, for example, an ascending order or a descending order of the frequency. Then, if an autocorrelation sequence R(i) (i=0, 1, 2, . . . , N-1) of phase spectrum sequences calculated in accordance with the following expression makes an impulse, then the phase random band detection unit 12 may determine that the phase spectrum of the focused sub band is random.

$$R ( i ) = \frac{1}{N} {\sum }_{j = 0}^{N - 1} ϕ ( j ) \cdot ϕ ( ( j + i ) \% N ) \qquad ( 1 )$$

It is to be noted that, when the autocorrelation sequence R(i) exceeds a given threshold value (for example, 0.1 to 0.9) only when i is equal to 0 or an integral number of times of N, the phase random band detection unit 12 may determine that the autocorrelation sequence R(i) makes an impulse.

It is to be noted that the phase random band detection unit 12 may determine that a sub band with regard to which it is determined that a criterion for the determination that the phase spectrum is random is satisfied by two or more determination methods from among the plurality of determination methods described hereinabove has a random phase spectrum.

The phase random band detection unit 12 notifies the outline information extraction unit 13 and the random component removal unit 14 of information representative of a sub band whose phase spectrum is random, for example, frequencies of an upper limit and a lower limit of the sub band or a number allocated to each sub band. In the following description, a sub band whose phase spectrum is random is referred to as noise band for the convenience of description.

The outline information extraction unit 13 extracts, with regard to a noise band, outline information that is information representative of an outline shape of an amplitude spectrum that is an amplitude component of a frequency signal for each frame.

In the present embodiment, the outline information extraction unit 13 approximates the amplitude spectrum of each frequency included in a noise band by a quadratic function using a least-square method or regression analysis. For example, if the quadratic function A(ω) used for the approximation is represented by aω²+bω+c, then the coefficients a, b and c of the orders which are parameters representative of the quadratic function A(ω) are calculated in accordance with the following expression.

$$( \begin{matrix}a \\ b \\ c\end{matrix} ) = {[ \begin{matrix}\sum {ω}_{i}^{4} & \sum {ω}_{i}^{3} & \sum {ω}_{i}^{2} \\ \sum {ω}_{i}^{3} & \sum {ω}_{i}^{2} & \sum {ω}_{i} \\ \sum {ω}_{i}^{2} & \sum {ω}_{i} & \sum 1\end{matrix} ]}^{- 1} ( \begin{matrix}\sum {ω}_{i}^{2} {A}_{i} \\ \sum {ω}_{i} {A}_{i} \\ \sum {A}_{i}\end{matrix} ) \qquad ( 2 )$$

where ωᵢ (i=0, 1, . . . , N-1) represents a frequency included in the noise band, and Aᵢ represents an amplitude spectrum at the frequency ωᵢ. Further, N represents the total number of frequencies included in the noise band.

The outline information extraction unit 13 calculates the parameters a, b and c for each noise band and outputs the parameters as outline information to the coupling unit 16 together with information representative of the noise band.

Alternatively, where a plurality of noise bands are involved, the outline information extraction unit 13 may calculate the parameters a, b and c in accordance with the expression (2) for each noise band. Alternatively, the outline information extraction unit 13 may group a plurality of noise bands for each set of noise bands adjacent each other and calculate the parameters a, b and c in accordance with the expression (2) for each group.

Alternatively, the outline information extraction unit 13 may approximate the amplitude spectrum of each frequency included in a noise band by a function different from a quadratic function such as, for example, a linear function or a cubic function and output parameters representative of the function used for the approximation as outline information to the coupling unit 16.

The random component removal unit 14 removes a frequency signal included in a noise band from a frequency signal of a sound signal so as not to be included in an encoding target for each frame. In the present embodiment, the random component removal unit 14 replaces the amplitude spectrum of each frequency included in the noise band with 0 to generate a correction frequency signal. Then, the random component removal unit 14 outputs the correction frequency signal for the entire frequency band after the replacement to the encoding unit 15.

Alternatively, the random component removal unit 14 may output information representative of a noise band to the encoding unit 15 together with the frequency signal of the overall frequency band. Alternatively, the random component removal unit 14 may output the remaining frequency signals when the frequency signals in a noise band are removed from the frequency signals of the overall frequency band to the encoding unit 15 together with information representative of the noise band.

The encoding unit 15 encodes a frequency signal included in a frequency band other than the noise band with high efficiency in accordance with a given encoding method for each frame to reduce the data amount, thereby obtaining an encoded sound signal regarding the frequency band other than the noise band. It is to be noted that it is estimated that the frequency signal included in the frequency band other than the noise band includes a tone component in the sound signal. Further, the encoding unit 15 may use, for example, CELP, NELP or advanced audio coding (AAC) as the given encoding method.

The encoding unit 15 outputs the encoded sound signal to the coupling unit 16.

The coupling unit 16 couples outline information in a given order to the encoded sound signal to produce a data stream including the encoded sound signal and outputs the data stream.

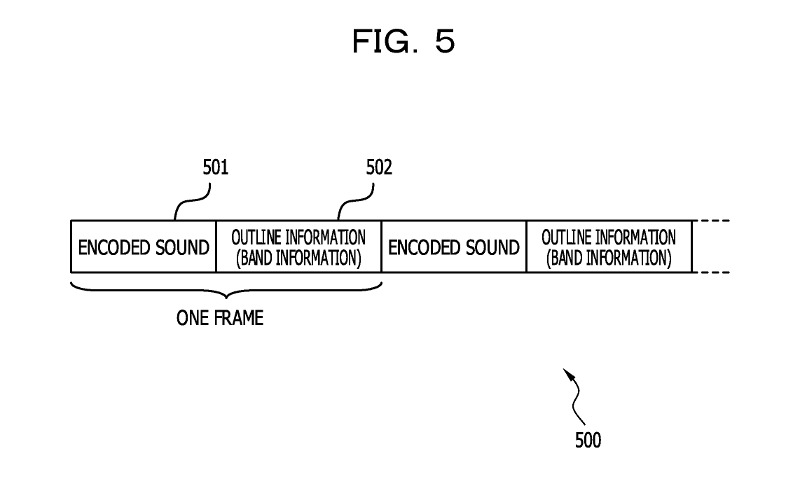

FIG. 5 is a view depicting an example of a data format in which an encoded sound signal is placed. A data stream 500 depicted in FIG. 5 includes a data block 501 and another data block 502 provided therein for each frame. The data block 501 includes an encoded sound signal generated by the encoding unit 15. The data block 502 includes outline information and information representative of a noise band both extracted by the outline information extraction unit 13. It is to be noted that the coupling unit 16 may store the outline information and the information representative of a noise band into the data block 502 after entropy-encoding the outline information and the information representative of the noise band.

Alternatively, the coupling unit 16 may produce a data stream in accordance with a different data format.

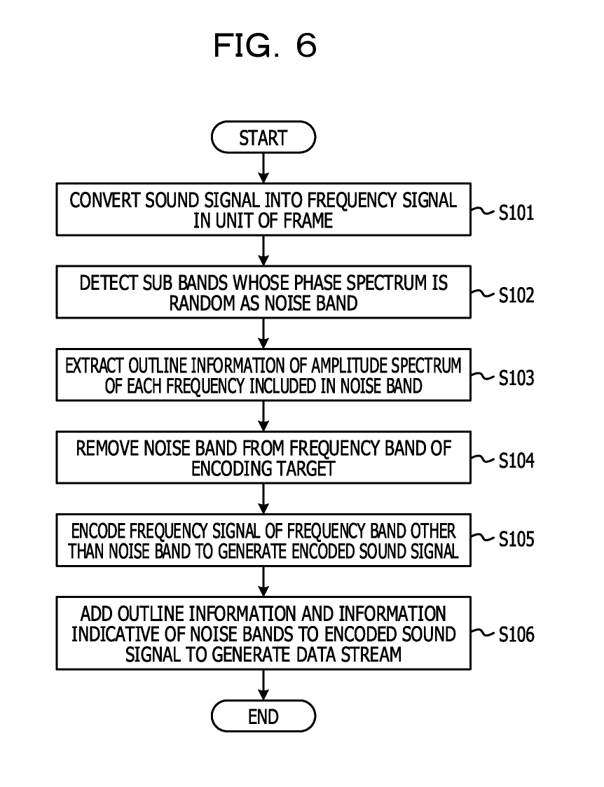

FIG. 6 is an operation flow chart of a sound encoding process. The sound encoding device 1 encodes a sound signal in accordance with the operation flow chart for each frame.

The time-frequency conversion unit 11 converts a sound signal into a frequency signal in a unit of a frame (step 101). The time-frequency conversion unit 11 outputs the frequency signal to the phase random band detection unit 12 and the random component removal unit 14.

The phase random band detection unit 12 determines for each sub band whether or not the phase spectrum is random and detects sub bands whose phase spectrum is random as a noise band (step S102). Then, the phase random band detection unit 12 outputs information representative of the noise band to the outline information extraction unit 13 and the random component removal unit 14.

The outline information extraction unit 13 extracts outline information of the amplitude spectrum of the frequencies included in the noise band (step S103). Then, the outline information extraction unit 13 outputs the outline information to the coupling unit 16. On the other hand, the random component removal unit 14 removes the noise band from the frequency band of the encoding target (step S104). Then, the encoding unit 15 encodes the frequency signal in the frequency band other than the noise band to obtain an encoded sound signal (step S105). The encoding unit 15 outputs the encoded sound signal to the coupling unit 16.

The coupling unit 16 couples the outline information and the information representative of the noise bands in a given order to the encoded sound signal to produce a data stream including the encoded sound signal (step S106). Then, the sound encoding device 1 ends the sound encoding process.

It is to be noted that the process at step S103 and the processes at steps S104 and S105 may be executed in parallel, or the process at step S103 and the processes at steps S104 and S105 may be swapped in order.

Now, a sound decoding device is described. The sound decoding device determines, with regard to a noise band, a frequency signal wherein the phase spectrum is random over a noise band and besides the amplitude spectrum indicates an outline shape represented by outline information as a pseudo frequency signal that artificially represents the frequency signal in the noise band. Then, the sound decoding device decodes a sound signal by synthesizing the pseudo frequency signal in the noise band with a frequency signal in the other frequency band obtained by decoding an encoded sound signal.

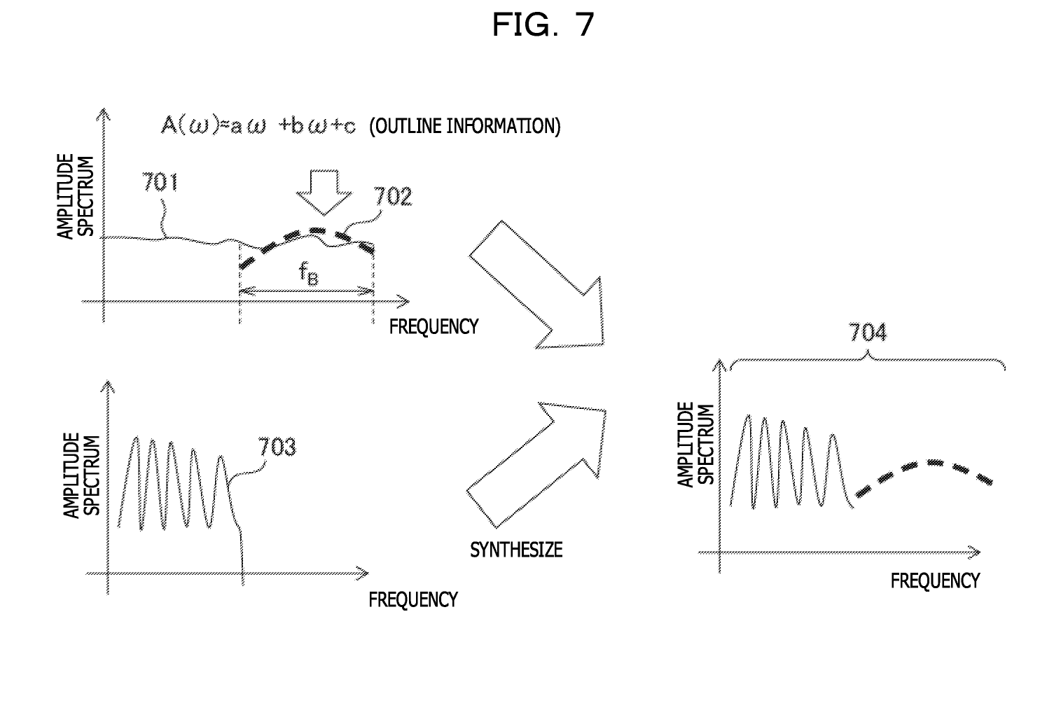

FIG. 7 is a view illustrating an outline of a sound decoding process. For example, referring to FIG. 7, a pseudo frequency signal 702 is obtained by shaping an outline shape of an amplitude spectrum in a portion of a signal 701, whose phase spectrum is random, included in the frequency band f_{B} into a shape represented by outline information A(ω). On the other hand, a frequency signal 703 in the frequency band other than the noise band f_{B} is obtained by decoding an encoded sound signal. Then, the pseudo frequency signal 702 and the frequency signal 703 are synthesized with each other to reproduce a frequency signal 704 in the overall frequency band.

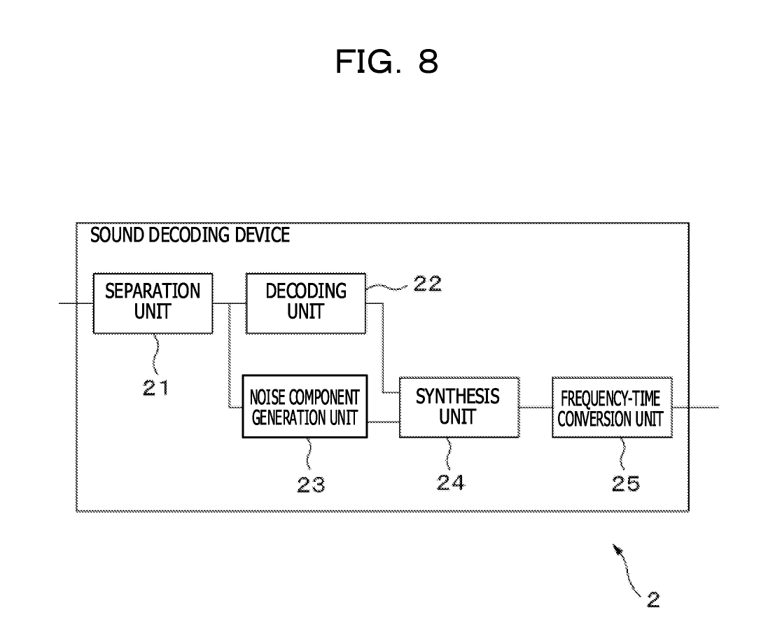

FIG. 8 is a schematic block diagram of a sound decoding device. A sound decoding device 2 includes a separation unit 21, a decoding unit 22, a noise component generation unit 23, a synthesis unit 24 and a frequency-time conversion unit 25.

The separation unit 21 extracts, from a data stream including an encoded sound signal, the encoded sound signal and outline information and information representative of a noise band in accordance with the data format of the data stream for each frame. Then, the separation unit 21 outputs the encoded sound signal and the information representative of a noise band to the decoding unit 22 for each frame while outputting the outline information and the information representative of a noise band to the noise component generation unit 23.

The decoding unit 22 decodes the encoded sound signal for each frame to reproduce a frequency signal included in a frequency band other than the noise band and having no outline information produced therefor. Thereupon, the decoding unit 22 executes, for the encoded sound signal, a decoding process corresponding to the encoding process by the encoding unit 15 of the sound encoding device 1. The reproduced frequency signal includes a tone component. Then, the decoding unit 22 outputs the reproduced frequency signal to the synthesis unit 24.

The noise component generation unit 23 generates a pseudo frequency signal for the noise band, which is the frequency band for which the outline information is produced, for each frame. The pseudo frequency signal indicates a random phase spectrum and indicates an amplitude spectrum in a form represented by the outline information. The pseudo frequency signal artificially represents a noise component included in the original sound signal. Therefore, the noise component generation unit 23 determines, for example, for every frequency in the noise band, a value of a phase spectrum on the basis of a random number generated using a random number generator to generate a random signal that has a ransom phase spectrum. Then, the noise component generation unit 23 determines an amplitude spectrum of the random signal in accordance with a function representative of an outline of the amplitude spectrum represented by parameters included in the outline information to generate a pseudo frequency signal.

The noise component generation unit 23 outputs the generated pseudo frequency signal to the synthesis unit 24.

The synthesis unit 24 synthesizes, for each frame, the frequency signal reproduced from the encoded sound signal and included in the frequency band other than the noise band and the pseudo frequency signal in the noise band to reproduce a frequency signal in the overall frequency band. Then, the synthesis unit 24 outputs the frequency signal in the overall frequency band to the frequency-time conversion unit 25.

The frequency-time conversion unit 25 frequency-time converts, for each frame, the frequency signal in the overall frequency band to reproduce a sound signal in the time domain. Then, the sound decoding device 2 outputs the reproduced sound signal to a speaker (not depicted), for example, through a digital/analog converter (hereinafter referred to as D/A converter) (not depicted).

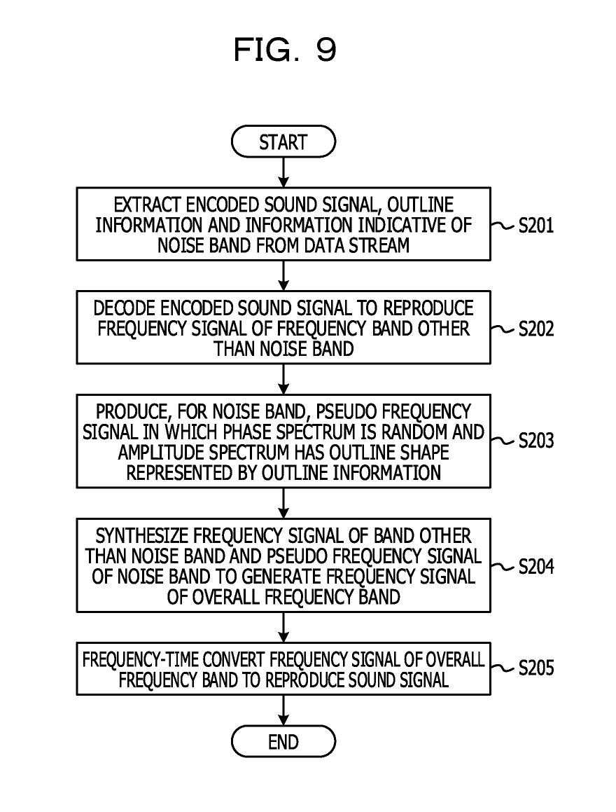

FIG. 9 is an operation flow chart of a sound decoding process executed by a sound decoding device. The sound decoding device that executes the sound decoding process in FIG. 9 may be the sound decoding device 2 depicted in FIG. 8. The sound decoding device 2 reproduces a sound signal in accordance with the operation flow chart described below for each frame.

The separation unit 21 extracts, from a data stream including an encoded sound signal, the encoded sound signal and outline information and information representative of a noise band (step S201). Then, the separation unit 21 outputs the encoded sound signal and the information representative of a noise band to the decoding unit 22 while outputting the outline information and the information representative of a noise band to the noise component generation unit 23.

The decoding unit 22 decodes the encoded sound signal to reproduce a frequency signal of a frequency band other than the noise band (step S202). Then, the decoding unit 22 outputs the reproduced frequency signal to the synthesis unit 24. Meanwhile, the noise component generation unit 23 generates, for the noise band, a pseudo frequency signal that indicates a random phase spectrum and indicates an amplitude spectrum having an outline shape represented by the outline information (step S203). Then, the noise component generation unit 23 outputs the pseudo frequency signal of the noise band to the synthesis unit 24.

The synthesis unit 24 synthesizes the frequency signal of the frequency band other than the noise band and the pseudo frequency signal of the noise band to each other to generate a frequency signal of the overall frequency band (step S204). Then, the synthesis unit 24 outputs the frequency signal of the overall frequency band to the frequency-time conversion unit 25.

The frequency-time conversion unit 25 frequency-time converts the frequency signal of the overall frequency band to reproduce a sound signal of the time domain (step S205). The sound decoding device 2 outputs the sound signal, for example, to the speaker through the D/A converter. Then, the sound decoding device 2 ends the sound decoding process.

It is to be noted that the sound decoding device 2 may execute the process at step S202 and the process at step S203 in parallel to each other. Alternatively, the sound decoding device 2 may swap the process at step S202 and the process at step S203 in order.

As described above, it is estimated that a frequency band having a random phase spectrum includes a noise component while it is estimated that a frequency band having no random phase spectrum includes a tone component. Therefore, the present sound encoding device does not encode a frequency signal in a frequency band in which the phase spectrum is random, but determines outline information of an amplitude spectrum of the frequency signal and adds the outline information to the encoded sound signal. Therefore, even if a sound signal of an encoding target includes both of a tone component and a noise component, the sound decoding device may reproduce both of the tone component and the noise component in a reproduction sound signal obtained by decoding the encoded sound signal. Accordingly, the sound encoding device and the sound decoding device may improve the reproduction sound quality from a sound signal that includes a tone component and a noise component in a mixed manner. Further, since the sound encoding device places, in a frequency band in which the phase spectrum is random, only outline information of an amplitude spectrum into the encoded sound signal, the code amount may be reduced. Accordingly, the sound encoding device may reduce the encoding rate for a sound signal that includes a tone component and a noise component in a mixed manner.

It is to be noted that, according to a modification, the phase random band detection unit 12 of the sound encoding device 1 may convert, for each sub band, a phase spectrum sequence into a binary sequence and determine on the basis of the binary sequence whether or not the phase spectrum included in the sub band is random.

In this case, the phase random band detection unit 12 generates a binary sequence, for example, by setting, for each frequency included in a focused sub band, the value of the phase spectrum so as to be “0” if the value of the phase spectrum is equal to or higher than a given value (for example, 0) but so as to be “1” if the value of the phase spectrum is lower than the given value. Alternatively, the phase random band detection unit 12 may generate a binary sequence by representing the value of the phase spectrum of each frequency included in a focused sub band by a bit sequence and connecting the bit sequences of the frequencies in a given order (for example, in an ascending order of the frequency). Alternatively, the phase random band detection unit 12 may generate a binary sequence by ΔΣ-modulating a phase spectrum sequence in which values of phase spectrums of frequencies included in a focused sub band are lined up in a given order. In this case, the phase random band detection unit 12 may obtain a binary sequence by quantizing a value, which is obtained by subtracting, from a focused phase value included in a phase spectrum sequence, a quantization value (in this case, “0” or “1”) obtained with regard to the immediately preceding phase value to “0” or “1.”

After a binary sequence is obtained, the phase random band detection unit 12 determines on the basis of the binary sequence whether or not the phase spectrum is random.

For example, the phase random band detection unit 12 determines an appearance frequency p3(0) of a bit having the value of “0” and included in a binary sequence b(i) (i=0, 1, . . . , N-1, where N is the total number of bits included in the binary sequence) and an appearance frequency p3(1) of a bit having the value of “1” and included in the binary sequence b(i). Then, if a value obtained by dividing absolute values |p3(0)-p3(1)| of the differences of the appearance frequencies of the bits having the individual values by N is lower than a given threshold value (for example, 0.05), then the phase random band detection unit 12 determines that the phase spectrum is random.

Alternatively, the phase random band detection unit 12 determines, for each of a plurality of bit patterns determined in advance, the number of portions of the binary sequence b(i) which coincide with the bit pattern as an appearance frequency p4(k) of the bit pattern. Here, k=0, 1, . . . , Q-1, and Q is the total number of bit patterns. It is to be noted that the individual bit patterns have a bit length of 2 or more and besides are shorter than the binary sequence b(i). In particular, where the length of the bit patterns is represented by M, M satisfies M<N, preferably satisfies 100M<N or 1000M<N. For example, where M=3, the bit pattern becomes such a pattern as [010] or [110]. Further, the individual bit patterns are stored, for example, in a memory the phase random band detection unit 12 includes in advance.

If the appearance frequencies p4(k) of the bit patterns indicate a uniform distribution, then the phase random band detection unit 12 determines that the phase spectrum is random. It is to be noted that the determination of whether or not the appearance frequencies p4(k) indicate a uniform distribution is performed, for example, by a process similar to the process for the determination of whether or not the phase spectrum sequences indicate a uniform distribution in the embodiment described hereinabove. In particular, when the appearance frequencies p4(k) of the bit patterns are lower than a given threshold value, or when the adaptability obtained by a x-square test or the like is equal to or higher than a given threshold value, the phase random band detection unit 12 determines that the appearance frequencies p4(k) indicate a uniform distribution.

Alternatively, the phase random band detection unit 12 determines an appearance frequency p5(j) (j=1, 2, . . . , L, where L is a run length) for each run length which is a number by which bits included in the binary sequence b(i) and having an equal value successively appear. Then, the phase random band detection unit 12 determines for each run length whether or not the appearance frequency p5(j) is included in a range in value set in advance for the run length.

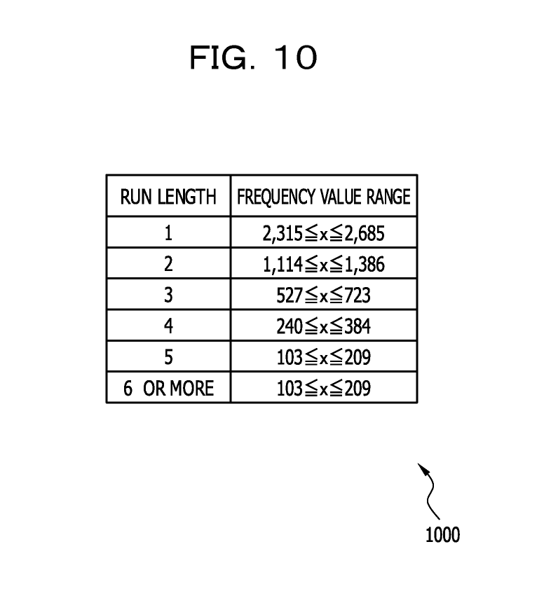

FIG. 10 is a view depicting an example of a table indicative of a range of a value of an appearance frequency for each run length. In this table 1000, the left side column represents a run length, namely, a number by which bits having the same value appear successively. Meanwhile, the right side column represents a range of the value of the appearance frequency corresponding to the run length indicated in the left side column in the case where the length of the binary sequence b(i) is 20000 bits (N=20000). For example, where the run length is 1, the range of the value corresponding to p5(1) is 2315≦p5(1)≦2685. It is to be noted that, where N is not 20000, the range in value of the frequency appearance for each run length may be made a value obtained by multiplying an upper limit value and a lower limit value of the appearance frequency indicated in the table 1000 by N/20000.

When the appearance frequency p5(j) of each run length is included in the range defined by given values, the phase random band detection unit 12 determines that the phase spectrum is random. On the other hand, when the appearance frequency p5(j) of any one of the run lengths comes out of the range defined by its given values, the phase random band detection unit 12 determines that the phase spectrum is not random.

Furthermore, the phase random band detection unit 12 may calculate a linear complexity of the binary sequence b(i). It is to be noted that the linear complexity is an index that represents a magnitude of a minimum linear feedback register that generates a binary sequence. If the linear complexity is higher than a given threshold value, then the phase random band detection unit 12 may determine that the phase spectrum is random, but if the linear complexity is equal to or lower than the given threshold value, the phase random band detection unit 12 may determine that the phase spectrum is not random. In this case, the phase random band detection unit 12 calculates the given threshold value, for example, by applying the Berlekamp Massey algorithm to the binary sequence b(i). For example, where the length of the binary sequence b(i) is 512 bits (N=512), the given threshold value is set to 8. Alternatively, the phase random band detection unit 12 may determine that the phase spectrum is random when the adaptability obtained by applying the χ-square test to the linear complexity is higher than a given threshold value.

With the present modification, since the phase random band detection unit 12 determines whether or not the phase spectrum included in a sub band is random on the basis of a binary sequence that includes only two different values, the arithmetic operation amount for the determination may be reduced.

Meanwhile, according to a different modification, the phase random band detection unit 12 of the sound encoding device 1 may determine not only the random nature of a phase spectrum but also whether or not there is a tone property of an amplitude spectrum for each sub band. In this case, the phase random band detection unit 12 may use only a sub band having no tone property as an extraction target of an outline shape.

In this case, the phase random band detection unit 12 calculates, for example, for each sub band, a flatness of power of each frequency included in the sub band (spectral flatness measure: SFM) in accordance with an expression given below. Then, when the flatness SFM is equal to or lower than a given threshold value, the phase random band detection unit 12 determines that the amplitude spectrum of the sub band has a tone property, but when the flatness SFM is higher than the given threshold value, the phase random band detection unit 12 determines that the amplitude spectrum of the sub band does not have a tone property.

$$SFM = \frac{\sqrt[N]{{\prod }_{i = 0}^{N - 1} \frac{A ( i )}{e ( i )}}}{\frac{1}{N} {\sum }_{i = 0}^{N - 1} \frac{A ( i )}{e ( i )}} \qquad ( 3 )$$

where A(i) represents the amplitude spectrum of the frequency i, and e(i) represents an envelope of the amplitude spectrum. It is to be noted that e(i) may be an approximate function represented by outline information obtained by the outline information extraction unit 13 in place of the envelope. Furthermore, the given threshold value may be, for example, 0.005.

Alternatively, the phase random band detection unit 12 may determine that, when the ratio of a maximum value of the amplitude spectrum to an average value of the amplitude spectrum of the frequencies in a sub band is higher than a given value, the amplitude spectrum of the sub band has a tone property. On the other hand, when the ratio is equal to or lower than the given value, the phase random band detection unit 12 may determine that the amplitude spectrum of the sub band does not have a tone property. In this case, the given value may be, for example, 2.

It is to be noted that, also in this modification, the phase random band detection unit 12 may determine whether or not the phase spectrums included in a sub band are random in accordance with the embodiment or any modification described above. Further, the phase random band detection unit 12 may specify a sub band in which the phase spectrum is random and besides the amplitude spectrum does not have a tone property and notify the outline information extraction unit 13 and the random component removal unit 14 of the specified sub band as a noise band.

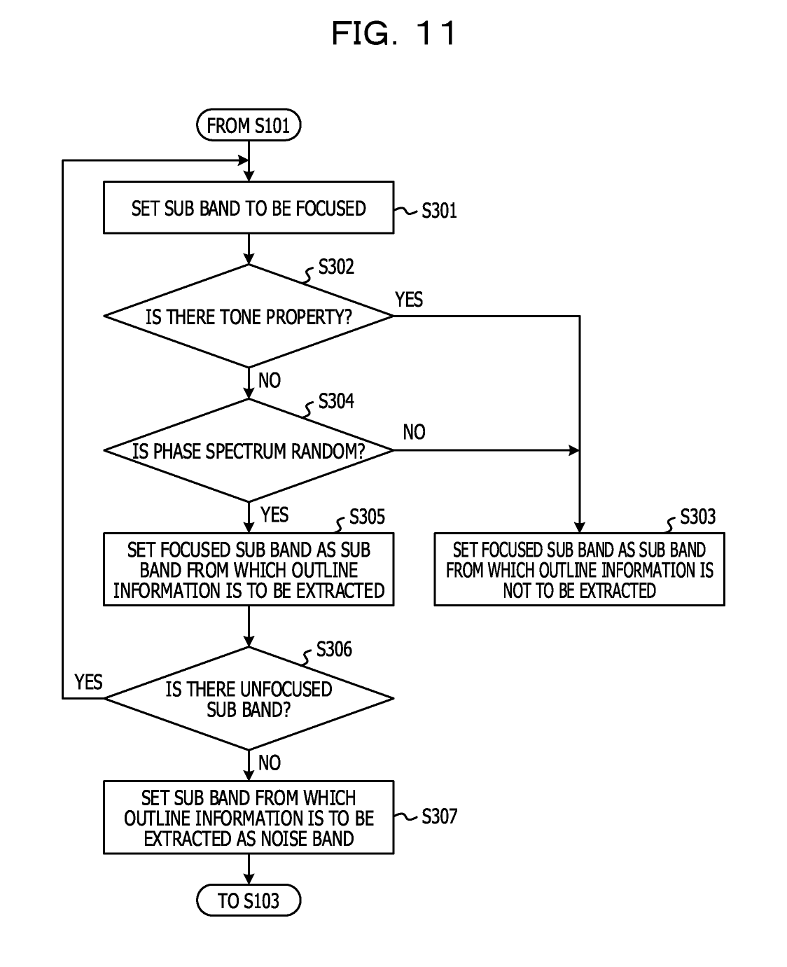

FIG. 11 is an operation flow chart of a phase random band detection process according to a modification. This phase random band detection process is executed in place of the process at step S102 in the operation flow chart of the sound encoding process depicted in FIG. 6.

The phase random band detection unit 12 sets a focused sub band from among sub bands that are not yet set as a focused sub band (step S301). Then, the phase random band detection unit 12 determines whether or not the amplitude spectrum of the focused sub band has a tone property (step S302). If the amplitude spectrum of the focused sub band has a tone property (step S302—Yes), then the phase random band detection unit 12 sets the focused sub band as a sub band from which outline information is not to be extracted (step S303). On the other hand, if the amplitude spectrum of the focused sub band does not have a tone property (step S302—No), then the phase random band detection unit 12 determines whether or not the phase spectrum of the focused sub band is random (step S304). If the phase spectrum of the focused sub band is not random (step S304—No), then the phase random band detection unit 12 sets the focused sub band as a sub band from which outline information is not to be extracted (step S303). On the other hand, if the phase spectrum of the focused sub band is random (step S304—Yes), then the phase random band detection unit 12 sets the focused sub band as a sub band from which outline information is to be extracted (step S305).

After step S303 or S305, the phase random band detection unit 12 determines whether or not a sub band that has not been focused as yet remains (step S306). If an unfocused sub band remains (step S306—Yes), then the phase random band detection unit 12 repeats the processes at the steps beginning with step S301. On the other hand, if an unfocused sub band does not remain (step S306—No), then the phase random band detection unit 12 determines the sub band from which outline information is to be extracted as a noise band and notifies the outline information extraction unit 13 and the random component removal unit 14 of information representative of the noise band (step S307). Thereafter, the phase random band detection unit 12 ends the phase random band detection process.

With the present modification, the sound encoding device may determine a sub band as an extraction target of outline information only when the amplitude spectrum in the sub band may be represented using a comparatively simple function such as a quadratic function.

According to a yet further modification, the outline information extraction unit 13 of the sound encoding device 1 may logarithmically transform an amplitude spectrum of each frequency included in a noise band. Then, the outline information extraction unit 13 may perform, for the logarithmic values of the amplitude spectrum of the frequencies obtained by the logarithmic transformation, a process similar to the extraction process of outline information by the embodiment described hereinabove to extract outline information of the amplitude spectrum. By this, the outline information extraction unit 13 may represent an outline of the amplitude spectrum using a function of a lower order.

According to a yet further modification, the outline information extraction unit 13 of the sound encoding device 1 may change over the function representative of outline information on the basis of the amplitude spectrum of a noise band. By this, when the outline shape of the amplitude spectrum in a noise band is comparatively simple, the outline information extraction unit 13 may use a function of a lower order as the function representative of the outline shape and may reduce the number of parameters representing the function. Therefore, the rate of the encoded sound signal may be reduced further. On the other hand, when the outline shape of the amplitude spectrum in the noise band is comparatively complicated, the outline information extraction unit 13 may use a function of a higher order as the function representative of the outline shape and may regenerate the outline shape accurately.

For example, the outline information extraction unit 13 calculates a correlation coefficient C of an amplitude and a frequency in a noise band in accordance with the following expression:

$$C = \frac{{\sum }_{i = 0}^{N - 1} ( A ( i ) - A avg ) \cdot ( ω ( i ) - ω avg )}{\sqrt{{\sum }_{i = 0}^{N - 1} {( A ( i ) - A avg )}^{2}} \sqrt{{\sum }_{i = 0}^{N - 1} {( ω ( i ) - ω avg )}^{2}}} \qquad ( 4 )$$

where ω(i) represents a frequency included in the noise band, and A(i) represents an amplitude spectrum at the frequency ω(i). Further, N represents the total number of a frequency that is included in the noise band and with regard to which an amplitude spectrum is calculated. Further, ωavg represents an average value of frequencies included in the noise band, and Aavg represents an average value of the amplitude spectrum of the frequencies included in the noise band. It is to be noted that the outline information extraction unit 13 may use some other calculation expression as the calculation expression for a correlation coefficient.

If the correlation coefficient C exceeds a given value (for example, 0.8), then the outline information extraction unit 13 uses a linear function as the function representative of the outline shape of the amplitude spectrum, but uses, if the correlation coefficient C is equal to or lower than the given value, a quadratic function as the function representative of the outline shape of the amplitude spectrum.

In the present modification, the outline information extraction unit 13 notifies the coupling unit 16 of a flag representative of a type of the function representative of the outline shape. Then, the coupling unit 16 places the flag into a data block in which information representative of a noise band and outline information in a data stream are placed.

A computer program that causes a computer to implement the functions of the components of the sound encoding devices according to the embodiment or the modifications described above may be provided in a form in which the computer program is stored in a recording medium such as a semiconductor memory, a magnetic recording medium or an optical recording medium. Similarly, a computer program that causes a computer to implement the functions of the components of the sound decoding devices according to the embodiment or the modifications described above may be provided in a form in which the computer program is stored in a recording medium such as a semiconductor memory, a magnetic recording medium or an optical recording medium.

Further, the sound encoding devices according to the embodiment or the modifications described above are incorporated in various apparatuses that are used to transmit or record a sound signal such as a monitoring camera, a computer, a recording machine for a video signal or a video transmission device. Further, the sound decoding devices according to the embodiment or the modifications described above are incorporated in various apparatuses that are used to reproduce a sound signal such as a monitor device of a monitoring system, a computer and a reproduction machine of a video signal.

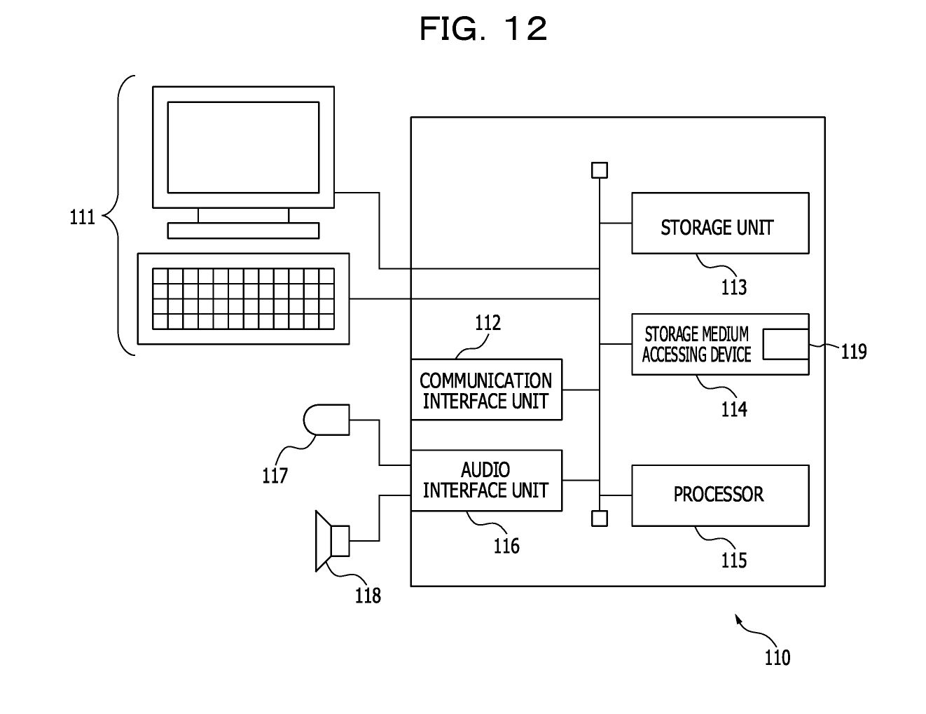

FIG. 12 is a block diagram of a computer that operates as a sound encoding device or a sound decoding device according to any one of the embodiment and modifications.

A computer 110 includes a user interface unit 111, a communication interface unit 112, a storage unit 113, a storage medium accessing device 114, a processor 115 and an audio interface unit 116. The processor 115 is coupled to the user interface unit 111, the communication interface unit 112, the storage unit 113, the storage medium accessing device 114 and the audio interface unit 116, for example, through a bus.

The user interface unit 111 includes an inputting device such as, for example, a keyboard and a mouse, and a display device such as a liquid crystal display unit. Alternatively, the user interface unit 111 may include an apparatus in which an inputting device and a display device are integrated like a touch panel display unit. The user interface unit 111 outputs an operation signal for selecting a sound signal to be encoded or decoded to the processor 115, for example, in response to an operation thereof by a user.

The communication interface unit 112 includes a communication interface and a control circuit for the communication interface configured to couple the computer 110 to a communication network that complies with a communication standard like the Ethernet (registered trademark). The communication interface unit 112 transmits, for example, a data stream including an encoded sound signal to a different apparatus. Alternatively, the communication interface unit 112 receives, for example, a data stream including an encoded sound signal from a different apparatus.

The storage unit 113 includes, for example, a readable and writable semiconductor memory and a read-only semiconductor memory. The storage unit 113 stores therein a computer program to be executed on the processor 115 for executing a sound encoding process or a sound decoding process and data produced during or as a result of processing of the computer program.

The storage medium accessing device 114 is a device configured to access a storage medium 119 such as, for example, a magnetic disk, a semiconductor memory card and an optical recording medium. The storage medium accessing device 114 reads in the computer program, for example, stored in the storage medium 119, for a sound encoding process or a sound decoding process to be executed on the processor 115, and passes the computer program to the processor 115.

The processor 115 executes a computer program for implementing the processes of the components of the sound encoding device of any one of the embodiment and the modifications described hereinabove. Consequently, the processor 115 encodes a sound signal acquired from a microphone 117 through an A/D converter (not depicted) and the audio interface unit 116. Then, the processor 115 generates a data stream including the encoded sound signal. Alternatively, the processor 115 executes a computer program for implementing the processes of the components of the sound decoding device according to any one of the embodiment and the modifications described hereinabove to decode an encoded sound signal. Then, the processor 115 outputs the decoded sound signal to a speaker 118 through the audio interface unit 116 and a D/A converter (not depicted).

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A sound encoding device comprising:
a processor; and
a memory which stores a plurality of instructions, which when executed by the processor, cause the processor to execute:
converting a sound signal into a frequency signal by time-frequency converting the sound signal in a unit of a frame having a given time length;
detecting a first frequency band in which a phase component of the frequency signal is random for each frame;
determining outline information representative of an outline of an amplitude component of the frequency signal included in the first frequency band for each frame;
encoding the frequency signal included in a frequency band other than the first frequency band for each frame; and
producing a data stream including the encoded frequency signal and the outline information.

2. The device according to claim 1,
wherein the detecting sets a frequency band in which the amplitude component of the frequency signal does not have a tone component and besides the phase component of the frequency signal is random as the first frequency band.

3. The device according to claim 2,
wherein the detecting determines, where flatness of power of frequencies included in the first frequency band is higher than a given threshold value, that the amplitude component of the frequency signal included in the first frequency band does not have the tone component.

4. The device according to claim 2,
wherein the detecting determines, where a ratio of a maximum value of the amplitude component of the frequency signal to an average value of the amplitude component of the frequency signal included in the first frequency band is equal to or lower than a given value, that the amplitude component of the frequency signal included in the first frequency band does not have the tone component.

5. The device according to claim 1,
wherein the detecting divides an overall frequency band in which the frequency signal is included into a plurality of sub bands and determines, for each of the plurality of sub bands, that the sub band is set as the first frequency band where the phase component of the frequency signal included in the sub band is random.

6. The device according to claim 5,
wherein the detecting divides a range within which a value of the phase component is capable of taking into a plurality of partial intervals, specifies, with regard to one of the plurality of sub bands, a partial interval in which a value of the phase component of the frequency signal is included for each of a plurality of frequencies included in the sub band, calculates an appearance frequency that is a number by which the value of the phase component is included for each of the plurality of partial intervals, and determines, where the appearance frequencies in the plurality of partial intervals indicate a uniform distribution, that the phase component of the frequency signal included in the sub band is random.

7. The device according to claim 5,
wherein the detecting divides a range within which a value of the phase component is capable of taking into a plurality of partial intervals, allocates numbers different from each other to the plurality of partial intervals, specifies, with regard to one of the plurality of sub bands, a number of the partial interval in which a value of the phase component of the frequency signal of each of the plurality of frequencies included in the sub band is included, produces a partial interval sequence in which the specified numbers are lined up in a given order, calculates an appearance frequency for each of a plurality of patterns in which a given number of the numbers allocated to one of the plurality of partial intervals are lined up in the partial interval sequence, and determines, where the respective appearance frequencies of the plurality of patterns indicate a uniform distribution, that the phase component of the frequency signal included in the sub band is random.

8. The device according to claim 5,
wherein the detecting produces, with regard to one of the plurality of sub bands, a phase spectrum sequence in which values of the phase components of the respective frequency signals of the plurality of frequencies included in the sub band are lined up in a given order and determines, where an autocorrelation function of the phase spectrum sequence makes an impulse, that the phase component of the frequency signal included in the sub band is random.

9. The device according to claim 5,
wherein the detecting converts, with regard to one of the plurality of sub bands, a phase spectrum sequence in which values of the phase components of the respective frequency signals of the plurality of frequencies included in the sub band are lined up in a given order into a binary sequence and determines, where the binary sequence satisfies a given condition, that the phase component of the frequency signal included in the sub band is random.

10. The device according to claim 9,
wherein the detecting determines, where an absolute value of a difference between an appearance frequency of a bit having a first value and another appearance frequency of a bit having a second value different from the first value in the binary sequence is within a range of a given value, that the binary sequence satisfies the given condition.

11. The device according to claim 9,
wherein the detecting calculates an appearance frequency of each of a plurality of bit patterns having a given length in the binary sequence and determines, where the appearance frequencies of the plurality of bit patterns indicate a uniform distribution, that the binary sequence satisfies the given condition.

12. The device according to claim 9,
wherein the detecting calculates an appearance frequency of each run length of a bit, which has a given value, included in the binary sequence and determines for each run length, where the appearance frequency of the run length is included within a given range determined for the run length, that the binary sequence satisfies the given condition.

13. The device according to claim 9,
wherein the detecting calculates a linear complexity of the binary sequence and determines, where the linear complexity is higher than a given value, that the binary sequence satisfies the given condition.

14. The device according to claim 1,
wherein the determining approximates the amplitude component of the frequency signal of each of the plurality of frequencies included in the first frequency band by a given function and determines a parameter indicative of the given function as the outline information.

15. The device according to claim 14,
wherein the determining calculates an autocorrelation value between the amplitude component of the frequency signal of each of the plurality of frequencies included in the first frequency band and the frequency and determines, where the autocorrelation value exceeds a given correlation value, a function of a first order as the given function but determines, where the autocorrelation value is equal to or lower than the given correlation value, a function of a second order higher than the first order as the given function.

16. The device according to claim 1,
wherein the plurality of instructions further cause the processor to execute:
generating a correction frequency signal by setting the amplitude component of the frequency signal of each of the plurality of frequencies included in the first frequency band to zero; and
the encoding generates the encoded frequency signal by encoding the correction frequency signal.

17. A sound decoding device comprising:
a processor; and
a memory which stores a plurality of instructions, which when executed by the processor, cause the processor to execute:
extracting, from a data stream including, for each frame having a given time length, outline information indicative of an outline of an amplitude component of a frequency signal of a plurality of frequencies included in a first frequency band from within frequency signals obtained by time-frequency conversion of a sound signal and the frequency signal of an encoded form included in a second frequency band other than the first frequency band, the outline information and the encoded frequency signal;
decoding the frequency signal included in the second frequency band by decoding the encoded frequency signal;
generating a frequency signal of the first frequency band in which a phase component is random and an amplitude component is represented by the outline information;
synthesizing the frequency signal included in the first frequency band and the frequency signal included in the second frequency band; and
reproducing a sound signal by frequency-time converting the synthesized frequency signal.

18. A sound encoding method comprising:
converting a sound signal into a frequency signal by time-frequency converting the sound signal in a unit of a frame having a given time length;
detecting a first frequency band in which a phase component of the frequency signal is random for each frame;
determining, by a computer processor, outline information representative of an outline of an amplitude component of the frequency signal included in the first frequency band for each frame;
encoding the frequency signal included in a frequency band other than the first frequency band for each frame; and
producing a data stream including the encoded frequency signal and the outline information.

19. A sound decoding method comprising:
extracting, from a data stream including, for each frame having a given time length, outline information indicative of an outline of an amplitude component of a frequency signal of a plurality of frequencies included in a first frequency band from within frequency signals obtained by time-frequency conversion of a sound signal and the frequency signal of an encoded form included in a second frequency band other than the first frequency band, the outline information and the encoded frequency signal;
decoding the frequency signal included in the second frequency band by decoding the encoded frequency signal;
generating, by a computer processor, a frequency signal of the first frequency band in which a phase component is random and an amplitude component is represented by the outline information;
synthesizing the frequency signal included in the first frequency band and the frequency signal included in the second frequency band; and
reproducing a sound signal by frequency-time converting the synthesized frequency signal.
